(19) United States
(12) Patent Application Publication
(10) Pub. No.: US 2015/0380123 A1
(43) Pub. Date: Dec. 31, 2015

(54) PROCESS FOR PRODUCING CONDUCTIVE COATING FILM, AND CONDUCTIVE COATING FILM

(71) Applicant: TODA KOGYO CORP., Hiroshima-shi, Hiroshima (JP)

(72) Inventors: Takeshi YATSUKA, Otake-shi (JP); Chiho ITO, Otake-shi (JP); Yasuo KAKIHARA, Otake-shi (JP)

(21) Appl. No.: 14/771,365

(22) PCT Filed: Feb. 25, 2014
(86) PCT No.: PCT/JP2014/054534

§ 371 Date: Aug. 28, 2015

(30) Foreign Application Priority Data
Mar. 1, 2013 (JP) 2013-041218

(51) Int. Cl. H01B 1/02; H01B 5/14; H01B 13/30

(52) U.S. Cl. CPC H01B 1/026; H01B 13/30; H01B 5/14

(57) ABSTRACT

An object of the present invention is to provide a conductive coating film formed of a copper paste on an insulating substrate which has a good conductivity and a good adhesion property to the insulating substrate. The process for producing a conductive coating film according to the present invention comprising the steps of applying a copper paste comprising copper particles, a binder resin and a solvent as main components onto an insulating substrate to form a coating film on the substrate, and then drying the coating film to obtain a copper powder-containing coating film; treating the copper powder-containing coating film with an organic acid or an organic acid salt; and subjecting the thus treated copper powder-containing coating film to heat treatment with superheated steam. According to the present invention, it is possible to obtain a conductive coating film having a good conductivity and a good adhesion property to the insulating substrate.

### TECHNICAL FIELD

The present invention relates to a process for producing a conductive coating film that is excellent in adhesion to an insulating substrate and electric conductivity, and a conductive coating film produced by the process.

### BACKGROUND ART

In recent years, there is rapid progress of conductive circuits with a high density. The conventional subtractive process used for forming the conductive circuits in which a copper foil laminated on an insulating substrate is etched for patterning thereof requires a prolonged time and is complicated, resulting in production of a large amount of wastes. In this process of forming the conductive circuits by etching of the copper foil, unaimed lateral etching tends to occur in a lower portion of the circuits, so that there is a limitation to a width of the circuits that can be formed. In consequence, instead of the subtractive process, there has been noticed an additive process or a semi-additive process in which circuits are formed by plating. In addition, a printing process or a coating process using a conductive paste comprising conductive particles to form the conductive circuits has also been noticed. For example, in a screen printing method generally used for circuit printing, flake-like metal particles having a particle diameter of not less than several micrometers or the like are used as the conductive particles to form a circuit having a thickness of not less than 10 μm and thereby ensure a conductivity thereof. In order to form a circuit having a higher density, still finer metal particles have been developed.

In view of a good conductivity and a good stability with time, silver is generally used as a metal for the conductive particles. However, silver is not only expensive and a resource with a less output, but also has the problem concerning ion migration generated between circuits under high-temperature and high-humidity conditions.

Copper has been used as alternative conductive particles in place of silver. However, since copper particles tend to readily form an oxide layer on a surface thereof, there tends to arise such a problem that the copper particles are deteriorated in conductivity owing to the oxide layer. In addition, as the particle size of the copper particles is reduced, the adverse influence of the oxide layer on a conductivity of the particles tends to become more remarkable. In consequence, in order to reduce the oxide layer on the copper particles, it is required that the copper particles are subjected to reducing treatment at a temperature exceeding 300° C. in a reducing atmosphere such as hydrogen or to sintering treatment at a much higher temperature, whereby the conductivity of the copper particles becomes closer to that of a bulk copper. However, even the thus treated copper particles can be used only in limited applications in which an insulating substrate used therewith must be formed of a high heat-resistant material such as ceramic materials and glass.

A conductive paste using a polymer compound as an binder resin is known as a polymer-type conductive paste. The polymer-type conductive paste using the binder resin can ensure fixing of conductive particles and adhesion to a substrate. However, since the binder resin inhibits contact between the conductive particles, the polymer-type conductive paste tends to be deteriorated in conductivity. In general, as the proportion of the conductive particles to the binder resin in the conductive paste is increased, the adhesion of the conductive paste to the substrate is deteriorated, but the conductivity of the conductive paste is enhanced. When the proportion of the conductive particles is further increased, the conductivity of the conductive paste reaches a maximum value and then is decreased owing to increase in voids in the obtained coating film.

The conductive paste using a polymer compound as the binder resin can exhibit a conductivity owing to contact between the conductive particles. The conductivity of even the polymer-type conductive paste using silver particles tends to be reduced to about 1/10 to about 1/1000 time a conductivity of a bulk silver. It is general that the polymer-type conductive paste using copper particles is further deteriorated in conductivity as compared to the silver paste.

In the conventional arts, there has also been proposed the method of enhancing a conductivity of a coating film obtained from a polymer-type conductive paste. For example, in Patent Document 1, it is described that metal fine particles having a particle diameter of not more than 100 nm can be sintered at a temperature far lower than a melting point of a bulk metal to obtain a metal thin film having an excellent conductivity. Also, in Patent Document 2, it is described that a coating film obtained from a metal powder paste is treated with superheated steam.

However, it has been required that a coating film obtained from a conductive paste comprising copper particles is further improved in conductivity thereof, and therefore the conductivity of the coating film is still insufficient. Further, as the temperature used for treating the coating film with superheated steam increases, the resulting coating film can exhibit a higher conductivity, but there tends to arise such a problem that adhesion of the coating film to an insulating substrate is deteriorated.

### CITATION LIST

### Patent Literature

Patent Literature 1: Japanese Patent Application Laid-Open (KOKAI) No. 03-034211

Patent Literature 2: International Patent Application Laid-Open No. WO 2010/095672

### SUMMARY OF INVENTION

### Technical Problem

An object of the present invention is to provide a process for producing a conductive coating film using a copper paste comprising copper particles (copper powder) which has a good conductivity and can maintain good adhesion to an insulating substrate even when subjected to treatment with superheated steam.

### Solution to Problem

As a result of the present inventors' earnest study for solving the above conventional problems, the present invention has been attained. That is, the present invention includes the following aspects.

(1) A process for producing a conductive coating film, comprising the steps of:

applying a copper paste comprising copper particles, a binder resin and a solvent as main components onto an insulating substrate to form a coating film on the insulating substrate, and then drying the coating film to obtain a copper powder-containing coating film;

treating the copper powder-containing coating film with an organic acid or an organic acid salt; and

subjecting the thus treated copper powder-containing coating film to heat treatment with superheated steam.

(2) The process for producing a conductive coating film according to the above aspect (1), wherein the organic acid or the organic acid salt is a carboxylic acid compound, a sulfonic acid compound, a sulfinic acid compound or a metal salt, or an ammonium salt of any of these compounds.

(3) A conductive coating film produced by the process according to the above aspect (1) or (2).

### Advantageous Effects of Invention

The process for producing a conductive coating film according to the present invention comprises the steps of applying a copper paste comprising copper particles, a binder resin and a solvent as main components onto an insulating substrate to form a coating film on the insulating substrate, and then drying the coating film to obtain a copper powder-containing coating film; treating the copper powder-containing coating film with an organic acid or an organic acid salt; and subjecting the thus treated copper powder-containing coating film to heat treatment with superheated steam. By treating the copper powder-containing coating film with the organic acid or the organic acid salt, it is possible to partially dissolve or remove an oxide from a surface of the copper particles. Thereafter by subjecting the coating film to treatment with superheated steam, it is possible to further promote reduction of the oxide on the surface of the copper particles by superheated steam, and thereby enhance sintering between the copper particles. In addition, since the copper oxide also acts as a catalyst for decomposing the binder resin, the reduced amount of the oxide present on the surface of the copper particles is capable of lowering a degree of decomposition of the binder resin upon the treatment with superheated steam. As a result, it is possible to obtain a conductive coating film that is excellent in adhesion to the substrate and conductivity. Furthermore, since the reduced amount of the oxide present on the surface of the copper particles inhibits deterioration in adhesion property of the conductive coating film when allowed to stand under high temperature conditions, it is possible to improve a high-temperature durability of the conductive coating film which is generally required for circuit materials.

### DESCRIPTION OF EMBODIMENTS

The present invention relates to a process for producing a conductive coating film that is excellent in not only conductivity but also adhesion property and is formed on an insulating substrate. The “excellent conductivity” of the conductive coating film as used in the present invention means that the conductive coating film has a specific resistance of not more than 50 μΩ·cm. Also, the “excellent adhesion property” of the conductive coating film as used in the present invention means that when subjecting the conductive coating film to a rapid peel test as described in the below-mentioned Examples in which a cellophane tape is laminated onto the conductive coating film and rapidly peeled off, there occurs no peeling between the insulating substrate and the conductive coating film, or a proportion of the peeled portion between the insulating substrate and the conductive coating film, if observed, is not more than 10% based on a whole laminated portion therebetween. Further, the “excellent adhesion property” of the conductive coating film as used in the present invention also means that when subjecting the conductive coating film to evaluation for an adhesion property thereof (plating peel test) as described in the below-mentioned Examples, the conductive coating film has a peel strength of not less than 5 N/cm and preferably not less than 6 N/cm.

The copper paste used in the present invention is prepared by dispersing copper particles and a binder resin as main components in a solvent.

The copper particles used in the present invention may be in the form of copper particles comprising copper as a main component or a copper alloy comprising copper in an amount of not less than 80% by weight in which the surface of the respective copper particles may be coated with silver. In such a case, the copper particles may be completely coated with silver, or may be partially coated with silver such that a part of the copper is exposed to outside. In addition, the copper particles may be provided on the surface thereof with an oxide layer unless the resulting particles are inhibited from exhibiting a conductivity by the treatment with superheated steam. The shape of the copper particles may be any of a generally spherical shape, a dendritic shape, a flake-like shape or the like. As the copper particles or copper alloy particles, there may be used wet processing copper particles, electrolytic copper particles, atomized copper particles, vapor phase-reduced copper particles or the like.

The copper particles used in the present invention preferably have an average particle diameter of 0.01 to 20 μm. When the average particle diameter of the copper particles is more than 20 μm, it may be difficult to form a fine wiring pattern on the insulating substrate. On the other hand, when the average particle diameter of the copper particles is less than 0.01 μm, there tends to occur distortion of the resulting coating film owing to fusion between the fine particles upon the heat treatment, so that the coating film tends to be deteriorated in adhesion to the insulating substrate. The average particle diameter of the copper particles is more preferably in the range of 0.02 to 15 μm, still more preferably 0.04 to 4 μm and further still more preferably 0.05 to 2 μm. The average particle diameter of the copper particles may be determined from an average value of particle diameters of the 100 copper particles as measured by any of a transmission electron microscope, a field emission-type transmission electron microscope and a field emission-type scanning electron microscope. In the present invention, there may be used the copper particles that are different in particle diameter from each other, as long as the average particle diameter of the copper particles lies within the range of 0.01 to 20 μm.

The solvent used in the copper paste used in the present invention may be selected from those solvents capable of dissolving the binder resin therein, and may be either an organic compound or water. The solvent serves not only for dispersing the copper particles in the copper paste, but also for controlling a viscosity of the resulting dispersion. Examples of the organic solvent include alcohols, ethers, ketones, esters, aromatic hydrocarbons and amides.

Examples of the binder resin used in the copper paste used in the present invention include resins such as polyesters, polyurethanes, polycarbonates, polyethers, polyamides, polyamide imides, polyimides and acrylic resins. Among these resins, preferred are those having an ester bond, a urethane bond, an amide bond, an ether bond, an imide bond or the like from the viewpoint of a good dispersion stability of the copper particles.

The copper paste used in the present invention usually comprises the copper particles, the solvent and the binder resin. The contents of the solvent and the binder resin in the copper paste are 10 to 40 parts by weight and 3 to 30 parts by weight, respectively, based on 100 parts by weight of the copper particles. When the content of the binder resin in the copper paste is less than 3 parts by weight based on 100 parts by weight of the copper particles, the resulting coating film tends to be remarkably deteriorated in adhesion to the insulating substrate. On the other hand, when the content of the binder resin in the copper paste is more than 30 parts by weight based on 100 parts by weight of the copper particles, the copper particles tend to have a poor opportunity of being contacted with each other, so that it is not possible to ensure a good conductivity of the resulting coating film.

The copper paste used in the present invention may further comprise a curing agent, if required. Examples of the curing agent used in the present invention include a phenol resin, an amino resin, an isocyanate compound, an epoxy resin, an oxetane compound and the like. The curing agent may be used in an amount of 1 to 50% by weight based on the binder resin.

The copper paste used in the present invention may also comprise as the binder resin, a polymer comprising a functional group having an adsorptivity to metals such as a sulfonate group and a carboxylate group and may further comprise a dispersant. Examples of the dispersant include higher fatty acids such as stearic acid, oleic acid and myristic acid, fatty acid amides, fatty acid metal salts, phosphoric acid esters and sulfonic acid esters. The dispersant may be used in an amount of 0.1 to 10% by weight based on the binder resin.

Next, the process for producing the copper paste is described.

The copper paste may be produced by an ordinary method for dispersing particles in a liquid. For example, the copper particles and a binder resin solution may be mixed, if required, together with an additional amount of a solvent, and the resulting mixture may be dispersed by an ultrasonic method, a mixer method, a triple roll mill method, a ball mill method or the like. These dispersing methods may be used in combination of any two or more thereof. The dispersing treatment may be carried out at room temperature, or may be carried out under heating in order to reduce a viscosity of the dispersion.

The process for producing the conductive coating film according to the present invention comprises the steps of applying the copper paste onto the insulating substrate to form a coating film on the insulating substrate and then drying the coating film to obtain a copper powder-containing coating film; treating the copper powder-containing coating film with an organic acid or an organic acid salt; and subjecting the thus treated copper powder-containing coating film to heat treatment with superheated steam.

The insulating substrate used in the present invention may be any insulating substrate that is capable of withstanding the treatment with superheated steam. Examples of the insulating substrate include a polyimide-based resin sheet or film, a ceramic plate, a glass plate, a glass/epoxy laminated plate, and the like. Of these insulating substrates, preferred is a polyimide-based resin sheet or film.

Examples of the polyimide-based resin include polyimide precursor resins, solvent-soluble polyimide resins and polyamide imide resins. The polyimide-based resin may be obtained by polymerization according to an ordinary method. For example, there may be used the method of reacting a tetracarboxylic acid dianhydride and a diamine in a solution thereof at a low temperature to obtain a solution of a polyimide precursor, the method of reacting a tetracarboxylic acid dianhydride and a diamine in a solution thereof at a high temperature to obtain a solution of a solvent-soluble polyimide, the method of using an isocyanate as a raw material, the method of using an acid chloride as a raw material, or the like.

The sheet or film as the insulating substrate when formed of the polyimide precursor resin may be obtained by an ordinary method in which a solution of the precursor resin is formed into a film by a wet method, and then the resulting film is subjected to imidation reaction at a high temperature. The solvent-soluble polyimide resin or the polyamide imide resin is already imidized in the solution and therefore can be formed into a sheet or a film by the wet method.

The polyimide-based insulating substrate may be previously subjected to surface treatments such as corona discharge treatment, plasma treatment and alkali treatment.

As the raw material for producing the polyimide precursor resin or the solvent-soluble polyimide resin, there may be used the following compounds.

Examples of an acid component of the above resins include monoanhydrides, dianhydrides, esterified products, etc., of pyromellitic acid, benzophenone-3,3′,4,4′-tetracarboxylic acid, biphenyl-3,3′,4,4′-tetracarboxylic acid, diphenyl sulfone-3,3′,4,4′-tetracarboxylic acid, diphenyl ether-3,3′,4,4′-tetracarboxylic acid, naphthalene-2,3,6,7-tetracarboxylic acid, naphthalene-1,2,4,5-tetracarboxylic acid, naphthalene-1,4,5,8-tetracarboxylic acid, hydrogenated pyromellitic acid and hydrogenated biphenyl-3,3′,4,4′-tetracarboxylic acid. These acid components may be used alone or in the form of a mixture of any two or more thereof.

Examples of an amine component of the above resins include p-phenylenediamine, m-phenylenediamine, 3,4′-diaminodiphenyl ether, 4,4′-diaminodiphenyl ether, 4,4′-diaminodiphenyl sulfone, 3,3′-diaminodiphenyl sulfone, 3,4′-diaminobiphenyl, 3,3-diaminobiphenyl, 3,3′-diaminobenzanilide, 4,4′-diaminobenzanilide, 4,4′-diaminobenzophenone, 3,3′-diaminobenzophenone, 3,4′-diaminobenzophenone, 2,6-tolylenediamine, 2,4-tolylenediamine, 4,4′-diaminodiphenyl sulfide, 3,3′-diaminodiphenyl sulfide, 4,4′-diaminodiphenyl propane, 3,3′-diaminodiphenyl propane, 4,4′-diaminodiphenyl hexafluoropropane, 3,3′-diaminodiphenyl hexafluoropropane, 4,4′-diaminodiphenyl methane, 3,3′-diaminodiphenyl methane, 4,4′-diaminodiphenyl hexafluoroisopropylidene, p-xylenediamine, m-xylenediamine, 1,4-naphthalenediamine, 1,5-naphthalenediamine, 2,6-naphthalenediamine, 2,7-naphthalenediamine, o-tolidine, 2,2′-bis(4-aminophenyl)propane, 2,2′-bis(4-aminophenyl)hexafluoropropane, 1,3-bis(3-aminophenoxy)benzene, 1,3-bis(4-aminophenoxy)benzene, 1,4-bis(4-aminophenoxy)benzene, 2,2-bis[4-(4-aminophenoxyl)phenyl]propane, bis[4-(4-aminophenoxyl)phenyl]sulfone, bis[4-(3-aminophenoxyl)phenyl]propane, bis[4-(3-aminophenoxyl)phenyl]sulfone, bis[4-(3-aminophenoxyl)phenyl]hexafluoropropane, 4,4′-bis(4-aminophenoxy)biphenyl, 4,4′-bis(3-aminophenoxy)biphenyl, 2,2-bis[4-(4-aminophenoxyl)phenyl]hexafluoropropane, cyclohexyl-1,4-diamine, isophoronediamine, hydrogenated 4,4′-diaminodiphenylmethane, and corresponding diisocyanate compounds thereof. These amine components may be used alone or in the form of a mixture of any two or more thereof.

In addition, resins separately produced by polymerizing these acid components and amine components in combination with each other may be mixed in the above polyimide precursor resin or the solvent-soluble polymer resin.

Examples of an acid component as a raw material of the polyamide imide resins include tricarboxylic anhydrides such as trimellitic anhydride, diphenyl ether-3,3′,4′-tricarboxylic anhydride, diphenyl sulfone-3,3′,4′-tricarboxylic anhydride, benzophenone-3,3′,4′-tricarboxylic anhydride, naphthalene-1,2,4-tricarboxylic anhydride, and hydrogenated trimellitic anhydride. These acid components may be used alone or in the form of a mixture of any two or more thereof. The tricarboxylic anhydrides may be used in combination with tetracarboxylic acids or anhydrides thereof, dicarboxylic acids, etc., which are mentioned above with respect to the polyimide resins.

Examples of an amine component as a raw material of the polyamide imide resins include the diamines and diisocyanates which are mentioned above with respect to the polyimide resins. These amine components may be used alone or in the form of a mixture of any two or more thereof.

In addition, resins separately produced by polymerizing these acid components and amine components in combination with each other may be mixed in the above polyamide imide resin.

In the case of using the polyimide-based insulating substrate, it is preferred that a resin cured layer as an anchor coat layer is formed between the polyimide-based insulating substrate and the copper powder-containing coating film.

Examples of a material constituting the resin cured layer provided on the polyimide-based insulating substrate include a reaction product of the resin and the curing agent, a self-cured product of a resin comprising a reactive functional group therein, a photo-crosslinked product, etc. By providing the resin cured layer, it is possible to obtain a conductive coating film that is more excellent in adhesion property after the treatment with superheated steam.

Examples of the resin used for the resin cured layer include polyesters, polyurethanes, polycarbonates, polyethers, polyamides, polyamide imides, polyimides and acrylic resins. Among these resins, preferred are those having an ester bond, an imide bond, an amide bond or the like from the viewpoints of a good heat resistance of the resin cured layer and a good adhesion property to the insulating substrate.

Specific examples of combinations of the materials for obtaining the resin cured layer are as follows. That is, there may be used combinations of a high acid value polyester and an epoxy compound; a polyester having a bisphenol A or resorcinol skeleton and a heat-curing phenol resin (resole resin); a high hydroxyl group content polyurethane and a polyisocyanate compound; and a polyester, an epoxy compound and a tetracarboxylic dianhydride. Also, the resin cured layer may be formed of a self-cured product of a resin having a reactive functional group therein. Examples of the resin having a reactive functional group therein include an oxetane-containing resin having an oxetane group and a carboxyl group, a resin having an alkoxysilane group therein, and an oxazoline-containing resin. Further, the resin cured layer may be readily produced from compounds that can be cured by irradiation with a visible light or a UV light such as photosensitive polyimides obtained by introducing a (meth)acryloyl group into a polyamic acid as a polyimide precursor through an ester bond, photosensitive polyimides obtained by adding an amine compound having a (meth)acryloyl group to a polyamic acid to form an ionic bond between an amino group and a carboxyl group therein, or the like.

The resin cured layer may be formed on the polyimide-based insulating substrate by applying an organic solvent solution or a water dispersion of the above resin onto the polyimide-based insulating substrate, and drying the resulting layer, if required, followed by subjecting the layer to heat treatment or irradiation with light.

The solvent-soluble content of the resin cured layer is not more than 20% by weight, in particular, preferably not more than 15% by weight. When the solvent-soluble content of the resin cured layer is more than 20% by weight, the resulting layer tends to be remarkably deteriorated in adhesion property owing to the superheated steam treatment. In addition, if the copper paste is applied on the coating film having a solvent-soluble content of more than 20% by weight, the resin cured layer is eroded by the solvent in the copper paste, and the obtained conductive coating film tends to be deteriorated in adhesion property and conductivity. Meanwhile, the solvent-soluble content of the resin cured layer means a content of components in the resin cured layer which are dissolved in the solvent when the resin cured layer is immersed in the solvent used for dissolving the resin at 25° C. for 1 hr.

The thickness of the resin cured layer formed on the polyimide-based insulating substrate is not more than 5 μm, in particular, preferably not more than 2 μm. When the thickness of the resin cured layer is more than 5 μm, the resin cured layer tends to be deteriorated in adhesion property owing to distortion generated upon curing of the resin cured layer, etc., so that the adhesion property of the resin cured layer tends to be more remarkably deteriorated when subjected to the superheated steam treatment. Meanwhile, when the thickness of the resin cured layer is not more than 0.01 μm, the resulting layer tends to be considerably deteriorated in adhesion property thereof when subjected to the treatment with superheated steam.

The method of forming the conductive coating film on the insulating substrate or on the resin cured layer that may be optionally formed on the insulating substrate, if required, using the copper paste used in the present invention, is explained below. Meanwhile, the conductive coating film may be provided over a whole surface of the insulating substrate, or may be in the form of a patterned film such as a conductive circuit. Further, the conductive coating film may be formed on one or both surfaces of the insulating substrate.

In order to form the copper powder-containing coating film on the insulating substrate or on the resin cured layer that may be optionally formed on the insulating substrate, if required, using the liquid copper paste, there may be used ordinary methods used for applying or printing the copper paste on a film or a sheet. For example, there may be used a screen printing method, a dip coating method, a spray coating method, a spin coating method, a roll coating method, a die coating method, an ink-jetting method, a letterpress printing method, an intaglio printing method, etc. By evaporating the solvent from the coating film formed by applying or printing the copper paste by heating, under reduced pressure or the like, it is possible to form the copper powder-containing coating film. In general, in the case of using the copper particles, the copper powder-containing coating film obtained at the stage of evaporating the solvent has a specific resistance of not less than 1 Ω·cm, and therefore does not exhibit yet a sufficient conductivity required for conductive circuits.

According to the present invention, even in the case where the copper paste is directly applied onto the insulating layer and dried, it is possible to attain a strong adhesion strength therebetween. However, when using the insulating substrate formed of the polyimide-based resin, the drying procedure may be completed after forming a primary dried product of a polyimide precursor solution or after forming the resin cured layer on a primary dried product of a polyimide solution or a polyamide imide solution, if required. Further, the drying procedure may be completed after applying the copper paste. Thus, while allowing 10 to 30% by weight of the solvent to remain in the primary dried product of the polyimide-based precursor solution or the polyimide-based solution, if required, after forming the resin cured layer on the primary dried product, the copper paste may be applied thereon and drying thereof may be then completed, whereby adhesion between the polyimide-based resin layer and the resin cured layer and between the resin cured layer and the copper powder-containing coating film can be more strengthened. As the solvent for the polyimide-based precursor solution or the polyimide-based solution, there may be generally used an amide-based solvent. Since the amide-based solvent has a poor drying property, it is required that the drying temperature thereof is increased to not lower than 150° C. In the case where the substrate onto which the copper paste is applied is dried, in order to suppress oxidation of the copper particles, it is preferred that the drying is conducted in an inert gas such as nitrogen or in an oxygen-free state such as superheated steam.

In the production process of the present invention, prior to the heat treatment with superheated steam, the copper powder-containing coating film is treated with an organic acid or an organic acid salt. The method of treating the copper powder-containing coating film with the organic acid or the organic acid salt is not particularly limited as long as the copper powder-containing coating film can be contacted with the organic acid or the organic acid salt, and there may be used a method of immersing the copper powder-containing coating film in an aqueous solution or an organic solvent solution of the organic acid or the organic acid salt, a method of spraying an aqueous solution or an organic solvent solution of the organic acid or the organic acid salt onto the copper powder-containing coating film, a method of exposing the copper powder-containing coating film to a vapor of the organic acid or the organic acid salt, or the like. Among them, preferred is a method of immersing the copper powder-containing coating film in an aqueous solution of the organic acid or the organic acid salt.

Examples of the organic acid used in the present invention include carboxylic acids, sulfonic acids and sulfinic acids. Examples of the organic acid salt include metal salts or ammonium salts of the above organic acids, i.e., metal salts or ammonium salts of carboxylic acids, sulfonic acids and sulfinic acids. Specific examples of compounds as the organic acid include monocarboxylic acids such as formic acid, acetic acid, propionic acid, butanoic acid and benzoic acid; polycarboxylic acids such as oxalic acid, succinic acid, adipic acid, itaconic acid, terephthalic acid and butanetetracarboxylic acid; oxyacids such as lactic acid, tartaric acid, malic acid, citric acid and gluconic acid; sulfonic acids such as methanesulfonic acid, benzenesulfonic acid and toluenesulfonic acid; sulfinic acids such as benzenesulfinic acid and toluenesulfinic acid; natural substances having a lactone structure such as L-ascorbic acid and isoascorbic acid; and the like. Specific examples of compounds as the organic acid salt include alkali metal salts, alkali earth metal salts and ammonium salts of the organic acids thus illustrated above. Of these compounds, preferred are fruit acids such as tartaric acid, malic acid, citric acid and glutaric acid, and fruit acid salts such as Rochelle salt, sodium citrate, sodium malate and calcium gluconate.

The conditions of the treatment with the organic acid and the organic acid salt may vary depending upon the compounds used. The immersion treatment with an aqueous solution of the fruit acids may be conducted, for example, under the conditions that the concentration of the aqueous solution is 1 to 50% by weight and preferably 2 to 20% by weight, the temperature of the aqueous solution is 10 to 80° C. and preferably 20 to 60° C., and the immersion time is 1 to 600 sec and preferably 10 to 100 sec.

In the production process of the present invention, it is preferred that the copper powder-containing coating film is washed and dried after treating the film with the organic acid or the organic acid salt but prior to the heat treatment with superheated steam. In the case where the copper powder-containing coating film is subjected to the heat treatment with superheated steam without being washed, impurities tend to remain on the copper powder-containing coating film, so that the resulting conductive coating film tends to be deteriorated in adhesion property and durability. In addition, when it is intended to further subject the conductive coating film to plating, the coating film tends to be deteriorated in plating suitability. The washing is usually conducted by washing the coating film with water, and the drying is usually conducted at 50 to 120° C.

In the production process of the present invention, the copper powder-containing coating film is subjected to the heat treatment with superheated steam to thereby obtain the aimed conductive coating film. In the production process of the present invention, as a heat source for the heat treatment, there is used superheated steam having larger heat capacity and specific heat than those of air. The superheated steam means a water vapor obtained by further heating a saturated water vapor to a higher temperature. An optimum temperature of the superheated steam used in the treatment may vary depending upon the aimed range of a conductivity of the conductive coating film as well as copper particles or the binder resin used therein.

The superheated steam treatment may be conducted in combination with infrared or far-infrared drying. The temperature of the superheated steam used in the treatment is in the range of 150 to 450° C. and preferably 200 to 400° C. When the temperature of the superheated steam is lower than 150° C., it may be difficult to attain sufficient effects by the treatment. When the temperature of the superheated steam is higher than 450° C., the resin might suffer from degradation. Although the superheated steam is held in an almost completely oxygen-free state, the heat treatment is conducted at an elevated temperature such as not lower than 150° C. upon the heat treatment, and it is therefore required that the oxygen concentration of the superheated steam is reduced, if inclusion of air thereinto tends to occur. In particular, in the case of the copper particles, since the copper particles are readily oxidized by oxygen at a high temperature, the resulting conductive coating film tends to be deteriorated in conductivity. For this reason, it is preferred that the oxygen concentration of the superheated steam is reduced to not more than 1% and more preferably not more than 0.1%.

The conductive coating film obtained by the production process of the present invention can exhibit a high conductivity. However, the conductive coating film may be further subjected to plating by an ordinary method in order to impart a still higher conductivity.

### EXAMPLES

The present invention is described in more detail by the following Examples. However, these Examples are only illustrative and therefore not intended to limit the invention thereto. The measurement values described in Examples, etc., were measured by the following methods.

### Degree of Oxidation of Copper Particles:

A copper powder-containing layer formed on an insulating substrate using a copper paste was subjected to measurement of peak intensity ratios of Cu₂O (1,1,1) and Cu (1,1,1) using an X-ray diffraction analyzer “D8 ADVANCE” manufactured by Bruker Corporation. The proportion of the intensity ratio of Cu₂O (1,1,1) based on the intensity ratio of Cu (1,1,1) as 1 was defined as a degree of oxidation of the copper particles.

### Specific Resistance:

The specific resistance was measured using a low resistivity meter “LORESTA GP” and a probe “ASP” manufactured by Mitsubishi Chemical Corp. Electrical resistance values were represented by the specific resistance values.

### Adhesion Property (Tape Peel Test):

A cellophane tape was laminated onto the conductive coating film and rapidly peeled off therefrom. The evaluation was conducted based on the following ratings.

A: No peeling occurred between the insulating substrate and the conductive coating film.

B: Peeling was recognized, but was less than 10% of a laminated area of the cellophane tape.

C: Peeling was recognized, and was not less than 10% of a laminated area of the cellophane tape.

### Adhesion Property (Plating Peel Test):

In the examples where no peeling occurred between the insulating substrate and the conductive coating film in the above tape peel test, the test piece on which the conductive coating film was formed was subjected to the following plating pretreatment, and then subjected to copper electroplating in the following plating bath to form a copper electroplating layer having 15 μm on the conductive coating film. After the elapse of one day, the plating layer was measured for a peel strength thereof.

### Plating Pretreatment

The test piece was immersed in an acidic degreasing agent “DP-320 CLEAN” produced by Okuno Chemical Industries Co., Ltd., at 50° C. for 3 min.

Plating bath (per 1 L)

| | |
|---|---|
| Copper sulfate pentahydrate | 200 g/L |
| Sulfuric acid | 60 g/L |
| Common salt | 0.1 g/L |

### High-Temperature Durability:

In the same manner as in the above evaluation for adhesion property, the test piece on which the conductive coating film was formed was subjected to the plating pretreatment, and then subjected to copper electroplating in the plating bath to form a copper electroplating layer having 15 μm on the conductive coating film. After allowing the test piece to stand at 150° C. for one week, the plating layer was measured for a peel strength thereof.

The peel strength was measured in such a manner that one edge of the plating layer on the test piece was torn-off at room temperature, and then the plating layer was pulled and peeled at a pulling rate of 100 mm/min from the one edge in the direction of folding the plating layer at an angle of 180° using a tensile tester.

### <Copper Particles Used>

### Copper Particles 1:

In water, a pH value of an aqueous copper (II) sulfate solution was adjusted to 12.5 using sodium hydroxide, and the copper (II) sulfate was reduced into copper (I) oxide using anhydrous glucose and thereafter further reduced into copper particles using hydrated hydrazine. The resulting particles were observed using a scanning electron microscope. As a result, it was confirmed that the particles were spherical particles having an average particle diameter of 0.12 μm.

### Copper Particles 2:

Copper (I) oxide suspended in water comprising tartaric acid was reduced into copper particles using hydrated hydrazine. The resulting particles were observed using a scanning electron microscope. As a result, it was confirmed that the particles were spherical particles having an average particle diameter of 1.5 μm.

<Polyimide Film with Resin Cured Layer>

The given composition was applied onto a polyimide film “APICAL NPI (thickness: 25 μm)” produced by KANEKA Corp., thereby forming the polyimide film with a resin cured layer.

### AC-1:

A polyester diol “RV220” (aromatic polyester; molecular weight: 2000) produced by TOYOBO Co., Ltd., benzophenone tetracarboxylic acid dihydrate (BTDA) and tetraethylamine as a reaction catalyst were reacted with each other at 70° C. using a mixed solvent comprising methyl ethyl ketone, toluene and cyclohexanone at a weight ratio of 1:1:1, thereby obtaining a solution of a polyester (Pes-1) having an acid value of 1000 equivalent/ton. After cooling Pes-1 to room temperature, a phenol novolak type epoxy resin “152” produced by Mitsubishi Chemical Corp., and triphenyl phosphine (TPP) were added thereto in amounts of 20% by weight and 1% by weight, respectively, based on the weight of Pes-1 to prepare a composition. The thus prepared composition was applied onto a polyimide film, and dried and heat-treated at 220° C. for 1 min. The thickness of the resin cured layer obtained after drying was 0.3 μm.

### AC-2:

A composition comprising a solution prepared by dissolving a bisphenol A skeleton-containing polyester (Pes-2; terephthalic acid/isophthalic acid//bis-A-containing diol/ethylene glycol=50/501/70/130 (molar ratio)) in a mixed solvent comprising methyl ethyl ketone and toluene at a weight ratio of 1:1, and a thermosetting phenol resin “RESITOP PL-2407” produced by GUN EI CHEMICAL INDUSTRY CO., LTD., and p-toluenesulfonic acid (p-TS) as a reaction catalyst, which were present in amounts of 30% by weight and 0.5% by weight, respectively, based on the weight of Pes-2, was applied onto a polyimide film, and dried and heat-treated at 200° C. for 2 min. The thickness of the resin cured layer obtained after drying was 0.3 μm. Pes-2 contains a diol formed by adding one molecule of ethyleneoxide to each hydroxyl group of bisphenol A as a diol component of the polyester.

### Example 1

The composition with the following formulation was charged into a sand mill, and dispersed at 800 rpm for 2 hr. As dispersing media, there were used zirconia beads having a radius of 0.2 mm. The obtained copper paste was applied onto the resin cured layer in the polyimide film with the resin cured layer (AC-1) using an applicator such that the thickness of the coating film obtained after drying was 2 μm, and then subjected to hot-air drying at 120° C. for 5 min, thereby obtaining a copper powder-containing coating film.

Composition of dispersion

| | |
|---|---|
| Copolyester solution | 2.5 parts |
| (in the form of a 40% by weight solution in | |
| toluene/cyclohexanone = 1/1 (weight ratio)) | |
| Copper particles 1 (average particle diameter: 0.12 μm) | 9 parts |
| γ-Butyrolactone (diluent) | 3.5 parts |
| Methyl ethyl ketone (diluent) | 5 parts |
| Oxetane | 0.2 part |
| (copolyester: “RV 290” produced by Toyobo Co., Ltd.; | |
| oxetane: “OXT-221” produced by Toagosei Co., Ltd.) | |

The resulting polyimide film with the copper powder-containing coating film was immersed in a 10% by weight malic acid aqueous solution at 50° C. for 1 min. The polyimide film was taken out of the solution, washed with water and dried, and then treated with superheated steam at 300° C. for 5 min. In the above treatment, a vapor heating apparatus “DHF Super-Hi10” manufactured by Dai-Ichi High Frequency Co., Ltd., was used as an apparatus for generating superheated steam, and the superheated steam generated therein was supplied to a heat treatment furnace at a rate of 10 kg/hr. The evaluation results of the resulting conductive coating film are shown in Table 1.

### Examples 2 to 4

The same procedure as in Example 1 was conducted except that the organic acid (salt) used in the organic acid (salt) treatment was changed as shown in Table 1, thereby obtaining conductive coating films. The evaluation results of the thus obtained conductive coating films are shown in Table 1.

### Examples 5 and 6

The same procedure as in Example 1 was conducted except that AC-2 was used as the insulating substrate, copper particles 2 were used as the copper particles, and the organic acid (salt) used in the organic acid (salt) treatment was changed as shown in Table 1, thereby obtaining conductive coating films. In Examples 5 and 6, the treatment with superheated steam was conducted at 330° C. The evaluation results of the thus obtained conductive coating films are shown in Table 1.

### Comparative Example 1

The same procedure as in Example 1 was conducted except that no treatment with the malic acid aqueous solution was conducted, thereby obtaining a conductive coating film. The evaluation results of the thus obtained conductive coating film are shown in Table 1.

### Comparative Examples 2 to 4

The same procedure as in Example 1 was conducted except that no treatment with the malic acid aqueous solution was conducted, and the immersion treatment was conducted at 50° C. for 1 min by immersing the film in a 10% by weight hydrochloric acid aqueous solution in Comparative Example 2, in a 10% by weight formalin aqueous solution in Comparative Example 3, and in a 10% by weight hydrazine aqueous solution in Comparative Example 4, thereby obtaining conductive coating films. The evaluation results of the thus obtained conductive coating films are shown in Table 1.

### Comparative Example 5

The same procedure as in Example 5 was conducted by using AC-2 as the insulating substrate and copper particles 2 as the copper particles except that no treatment with the L-ascorbic acid aqueous solution was conducted, thereby obtaining a conductive coating film. The treatment with superheated steam was conducted at 330° C. The evaluation results of the thus obtained conductive coating film are shown in Table 1.

### Comparative Example 6

The same procedure as in Example 5 was conducted by using AC-2 as the insulating substrate and copper particles 2 as the copper particles except that the treatment with the L-ascorbic acid aqueous solution was replaced with an immersion treatment with a 10% by weight hydrazine aqueous solution at 50° C. for 1 min, thereby obtaining a conductive coating film. The treatment with superheated steam was conducted at 330° C. The evaluation results of the thus obtained conductive coating film are shown in Table 1.

The conductive coating films obtained in Comparative Examples 1 and 5 in which no immersion treatment with the organic acid or other solutions was conducted, were deteriorated in conductivity and adhesion property as compared to the conductive coating films obtained in the other Examples in which the same copper particles were used. On the other hand, the conductive coating films obtained in Comparative Examples 2 to 4 and 6 in which the immersion treatment was conducted using the solutions other than the organic acid or organic acid salt, were slightly improved in in conductivity, but exhibited a low adhesion property.

TABLE 1

| | Examples | | | | | |
|---|---|---|---|---|---|---|
| | 1 | 2 | 3 | 4 | 5 | 6 |
| Insulating substrate | | | | | | |
| Polyimide film | AC-1 | AC-1 | AC-1 | AC-1 | AC-2 | AC-2 |
| Copper powder-containing | | | | | | |
| layer | | | | | | |
| Copper particles | CP1*¹ | CP1*¹ | CP1*¹ | CP1*¹ | CP2*² | CP2*² |
| Immersion treatment at | | | | | | |
| 50° C. for 1 min | | | | | | |
| Organic acid or organic | | | | | | |
| acid salt | | | | | | |
| Malic acid | ◯ | | | | | |
| Citric acid | | ◯ | | | | |
| Gluconic acid | | | ◯ | | | |
| Rochelle salt | | | | ◯ | | |
| L-ascorbic acid | | | | | ◯ | |
| p-Toluenesulfonic acid | | | | | | ◯ |
| Others | | | | | | |
| Hydrochloric acid | | | | | | |
| Formalin | | | | | | |
| Hydrazine | | | | | | |
| Superheated steam | | | | | | |
| treatment | | | | | | |
| Temperature (° C.) | 300 | 300 | 300 | 300 | 330 | 330 |
| Time (min) | 5 | 5 | 5 | 5 | 5 | 5 |
| Specific resistance | | | | | | |
| (μΩ · cm) | | | | | | |
| Before superheated steam | ≧10⁶ | ≧10⁶ | ≧10⁶ | ≧10⁶ | 1.6 × 10⁴ | ≧10⁶ |
| treatment | | | | | | |
| After superheated steam | 7.3 | 8.4 | 15.2 | 20.6 | 18.8 | 28.7 |
| treatment | | | | | | |
| Tape peel test (—) | A | A | A | A | A | A |
| Plating peel test | | | | | | |
| Peel strength (N/cm) | 10.3 | 8.2 | 11.2 | 11.6 | 6.7 | 7.3 |

| | Comparative Examples | | | | | |
|---|---|---|---|---|---|---|
| | 1 | 2 | 3 | 4 | 5 | 6 |
| Insulating substrate | | | | | | |
| Polyimide film | AC-1 | AC-1 | AC-1 | AC-1 | AC-2 | AC-2 |
| Copper powder-containing | | | | | | |
| layer | | | | | | |
| Copper particles | CP1*¹ | CP1*¹ | CP1*¹ | CP1*¹ | CP2*² | CP2*² |
| Immersion treatment at | | | | | | |
| 50° C. for 1 min | | | | | | |
| Organic acid or organic | | | | | | |
| acid salt | | | | | | |
| Malic acid | — | | | | — | |
| Citric acid | — | | | | — | |
| Gluconic acid | — | | | | — | |
| Rochelle salt | — | | | | — | |
| L-ascorbic acid | — | | | | — | |
| p-Toluenesulfonic acid | — | | | | — | |
| Others | | | | | | |
| Hydrochloric acid | — | ◯ | | | — | |
| Formalin | — | | ◯ | | — | |
| Hydrazine | — | | | ◯ | — | ◯ |
| Superheated steam | | | | | | |
| treatment | | | | | | |
| Temperature (° C.) | 300 | 300 | 300 | 300 | 330 | 330 |
| Time (min) | 5 | 5 | 5 | 5 | 5 | 5 |
| Specific resistance | | | | | | |
| (μΩ · cm) | | | | | | |
| Before superheated steam | ≧10⁶ | ≧10⁶ | 1.1 × 10⁴ | 3.6 × 10³ | ≧10⁶ | 3.8 × 10⁴ |
| treatment | | | | | | |
| After superheated steam | 21.1 | 13.3 | 8.9 | 7.3 | 38.4 | 31.1 |
| treatment | | | | | | |
| Tape peel test (—) | A | A | A | A | A | A |
| Plating peel test | | | | | | |
| Peel strength (N/cm) | 4.8 | 0.2 | 2.1 | 4.2 | 3.4 | 2.1 |

Note
*¹CP1: Copper particles 1;
*²CP2: Copper particles 2

### Examples 7 to 10

The same procedure as in Example 1 was conducted except that the conditions of the treatment with the 10% by weight malic acid aqueous solution was changed as shown in Table 2, thereby obtaining conductive coating films. The evaluation results of the thus obtained conductive coating films are shown in Table 2.

TABLE 2

| | Examples | | | |
|---|---|---|---|---|
| | 7 | 8 | 9 | 10 |
| Insulating substrate | | | | |
| Polyimide film | AC-1 | AC-1 | AC-1 | AC-1 |
| Copper powder- | | | | |
| containing layer | | | | |
| Copper particles | CP1*¹ | CP1*¹ | CP1*¹ | CP1*¹ |
| Immersion treatment | | | | |
| with organic acid | | | | |
| Malic acid | | | | |
| Temperature (° C.) | 20 | 20 | 60 | 60 |
| Time (min) | 0.5 | 3 | 0.5 | 3 |
| Superheated steam | | | | |
| treatment | | | | |
| Temperature (° C.) | 300 | 300 | 300 | 300 |
| Time (min) | 5 | 5 | 5 | 5 |
| Specific resistance | | | | |
| (μΩ · cm) | | | | |
| Before superheated steam | ≧10⁶ | ≧10⁶ | ≧10⁶ | ≧10⁶ |
| treatment | | | | |
| After superheated steam | 16.9 | 10.9 | 7.7 | 7.2 |
| treatment | | | | |
| Tape peel test (—) | A | A | A | A |
| Plating peel test | | | | |
| Peel strength (N/cm) | 6.3 | 8.1 | 9.4 | 10.2 |

Note
*¹CP1: Copper particles 1

### Examples 11 to 14

The polyimide film with the copper powder-containing coating film before subjected to the organic acid treatment in Example 1 was heat-treated in air at 180° C. The time of the heat treatment in the respective Examples was controlled as shown in Table 3 to vary a degree of oxidation of the copper particles. The sample obtained after the heat treatment at 180° C. was subjected to the same organic acid treatment with malic acid aqueous solution and the same treatment with superheated steam as those of Example 1. In Examples 13 and 14, the temperature of the superheated steam was raised to 330° C. and 350° C., respectively. The thus obtained conductive coating film was successively subjected to plating pretreatment and copper electroplating. The thus plated conductive coating film was measured for a peel strength thereof after the elapse of one day from the plating treatment, and further allowed to stand for one week at 150° C. after the plating treatment to measure a peel strength thereof. The evaluation results are shown in Table 3.

### Comparative Examples 7 to 10

The polyimide film with the copper powder-containing coating film before subjected to the organic acid treatment in Example 1 was heat-treated in air at 180° C. The time of the heat treatment in the respective Comparative Examples was controlled as shown in Table 3 to vary a degree of oxidation of the copper particles. The sample obtained after the heat treatment at 180° C. was subjected to the treatment with superheated steam without any organic acid treatment with malic acid aqueous solution, unlike the procedure of Example 1. In Comparative Examples 9 and 10, although the temperature of the superheated steam was raised to 330° C. and 350° C., respectively, the resulting films had a poor conductivity and therefore it was not possible to subject the films to copper electroplating. The conductive coating film obtained in each of Comparative Examples 7 and 8 was successively subjected to plating pretreatment and copper electroplating. The thus plated conductive coating film was measured for a peel strength thereof after the elapse of one day from the plating treatment, and further allowed to stand for one week at 150° C. after the plating treatment to measure a peel strength thereof. In addition, the conductive coating film obtained in each of Comparative Examples 9 and 10 was allowed to stand for one week at 150° C. and then subjected to tape peel test. The evaluation results are shown in Table 3.

In Comparative Examples 7 to 10, the resulting conductive coating films were considerably deteriorated in adhesion property because no treatments with the organic acid or organic acid salt was conducted therein. The reason therefor is considered to be that when heat-treating the copper powder-containing coating film subjected to the treatment with superheated steam or the conductive coating film subjected to high-temperature durability test which were kept under the condition that a large amount of a copper oxide still remained therein, the binder as an organic substance was decomposed. According to the present invention, since the copper oxide can be dissolved or removed from the surface of the respective copper particles by the treatment with the organic acid or organic acid salt, it is possible to stably produce a conductive coating film having high conductivity and adhesion property even when using the copper particles that tend to be oxidized.

TABLE 3

| | Examples | | | |
|---|---|---|---|---|
| | 11 | 12 | 13 | 14 |
| Insulating substrate | | | | |
| Polyimide film | AC-1 | AC-1 | AC-1 | AC-1 |
| Copper powder- | | | | |
| containing layer | | | | |
| Copper particles | CP1*¹ | CP1*¹ | CP1*¹ | CP1*¹ |
| Heat treatment at 180° C. | | | | |
| Time (min) | 0.5 | 1 | 3 | 7 |
| Degree of oxidation | 0.013 | 0.017 | 0.028 | 0.068 |
| Immersion treatment | | | | |
| with organic acid | | | | |
| Malic acid | ◯ | ◯ | ◯ | ◯ |
| Superheated steam | | | | |
| treatment | | | | |
| Temperature (° C.) | 300 | 300 | 330 | 350 |
| Time (min) | 5 | 5 | 5 | 5 |
| Specific resistance | | | | |
| (μΩ · cm) | | | | |
| Before superheated steam | ≧10⁶ | ≧10⁶ | ≧10⁶ | ≧10⁶ |
| treatment | | | | |
| After superheated steam | 9.4 | 15.6 | 18.8 | 21.1 |
| treatment | | | | |
| Tape peel test (—) | A | A | A | A |
| After allowed to stand at | — | — | — | — |
| 150° C. for one week | | | | |
| Plating peel test | | | | |
| Peel strength (N/cm) | 8.8 | 8.2 | 9.1 | 8.2 |
| Peel strength (N/cm) | 7.7 | 7.5 | 7.9 | 6.8 |
| after allowed to stand at | | | | |
| 150° C. for one week | | | | |
| | Comparative Examples | | | |
| | 7 | 8 | 9 | 10 |
| Insulating substrate | | | | |
| Polyimide film | AC-1 | AC-1 | AC-1 | AC-1 |
| Copper powder- | | | | |
| containing layer | | | | |
| Copper particles | CP1*¹ | CP1*¹ | CP1*¹ | CP*¹ |
| Heat treatment at 180° C. | | | | |
| Time (min) | 0.5 | 1 | 3 | 7 |
| Degree of oxidation | 0.013 | 0.017 | 0.028 | 0.068 |
| Immersion treatment | | | | |
| with organic acid | | | | |
| Malic acid | — | — | — | — |
| Superheated steam | | | | |
| treatment | | | | |
| Temperature (° C.) | 300 | 300 | 330 | 350 |
| Time (min) | 5 | 5 | 5 | 5 |
| Specific resistance | | | | |
| (μΩ · cm) | | | | |
| Before superheated steam | ≧10⁶ | ≧10⁶ | ≧10⁶ | ≧10⁶ |
| treatment | | | | |
| After superheated steam | 31.5 | 48.9 | ≧10⁶ | ≧10⁶ |
| treatment | | | | |
| Tape peel test (—) | A | A | C | C |
| After allowed to stand at | — | — | C | C |
| 150° C. for one week | | | | |
| Plating peel test | | | | |
| Peel strength (N/cm) | 5.1 | 3.6 | — | — |
| Peel strength (N/cm) | 1.2 | 0.4 | — | — |
| after allowed to stand at | | | | |
| 150° C. for one week | | | | |

Note
*¹CP1: Copper particles 1

### Example 15

An epoxy/glass cloth prepreg “EGL-7” produced by Nitto Shinko Corporation was laminated on a fluorocarbon polymer film as a release film, and the resulting laminate was cured at 180° C. under an applied pressure of 1 MPa for 1 hr and used as an insulating substrate.

The composition with the following formulation was charged into a sand mill, and dispersed at 800 rpm for 2 hr. As dispersing media, there were used zirconia beads having a radius of 0.2 mm. The obtained copper paste was applied onto the above epoxy/glass cloth using an applicator such that the thickness of the coating film obtained after dried was 10 μm, and then subjected to hot-air drying at 120° C. for 5 min, thereby obtaining a copper powder-containing coating film. The thus obtained copper powder-containing coating film was immersed in a 10% by weight gluconic acid aqueous solution at 50° C. for 1 min, and then washed with water and dried. The resulting epoxy/glass cloth with the copper powder-containing coating film was treated with superheated steam at 270° C. for 5 min. In the above treatment, a vapor heating apparatus “DHF Super-Hi10” manufactured by Dai-Ichi High Frequency Co., Ltd., was used as an apparatus for generating superheated steam, and the superheated steam generated therein was supplied to a heat treatment furnace at a rate of 10 kg/hr. The evaluation results of the resulting conductive coating film are shown in Table 4.

Composition of dispersion

| | |
|---|---|
| Copolyester solution | 2.5 parts |
| (in the form of a 40% by weight solution in | |
| toluene/cyclohexanone = 1/1 (weight ratio)) | |
| Copper particles 1 (average particle diameter: 0.12 μm) | 9 parts |
| γ-Butyrolactone (diluent) | 3.5 parts |
| Methyl ethyl ketone (diluent) | 5 parts |
| Blocked isocyanate | 0.2 part |
| (copolyester: “VYRON 300” produced by Toyobo Co., Ltd.; | |
| blocked isocyanate: “CORONATE 2546” produced by | |
| Nippon Polyurethane Industry Co., Ltd.) | |

### Examples 16 and 17

The same procedure as in Example 15 was conducted except that the gluconic acid aqueous solution as the organic acid (salt) used in the organic acid (salt) treatment was replaced with a 3% by weight calcium gluconate aqueous solution in Example 16 and a 10% by weight isoascorbic acid aqueous solution in Example 17, respectively, thereby obtaining conductive coating films. The evaluation results of the thus obtained conductive coating films are shown in Table 4.

### Comparative Example 11

In the same manner as in Example 15, an epoxy/glass cloth prepreg “EGL-7” produced by Nitto Shinko Corporation was laminated on a fluorocarbon polymer film as a release film, and the resulting laminate was cured at 180° C. under an applied pressure of 1 MPa for 1 hr and used as an insulating substrate. However, in Comparative Example 11, no treatment with the 10% by weight gluconic acid aqueous solution was conducted, thereby obtaining a conductive coating film. The evaluation results of the thus obtained conductive coating film are shown in Table 4.

TABLE 4

| Examples | | | Comp. |
|---|---|---|---|
| 15 | 16 | 17 | Ex. 11 |

Insulating substrate

| | | | | |
|---|---|---|---|---|
| Epoxy/glass cloth | ◯ | ◯ | ◯ | ◯ |
| Copper powder- | | | | |
| containing layer | | | | |
| Copper particles | CP1*¹ | CP1*¹ | CP1*¹ | CP1*¹ |
| Immersion treatment | | | | |
| with organic acid or | | | | |
| organic acid salt at | | | | |
| 50° C. for 1 min | | | | |
| Gluconic acid | ◯ | | | — |
| Calcium gluconate | | ◯ | | — |
| Isoascorbic acid | | | ◯ | — |
| Superheated steam | | | | |
| treatment | | | | |
| Temperature (° C.) | 270 | 270 | 270 | 270 |
| Time (min) | 5 | 5 | 5 | 5 |
| Specific resistance | | | | |
| (μΩ · cm) | | | | |
| Before superheated steam | ≧10⁶ | ≧10⁶ | 8.9 × 10⁴ | ≧10⁶ |
| treatment | | | | |
| After superheated steam | 15.7 | 27.5 | 8.1 | 48.6 |
| treatment | | | | |
| Tape peel test (—) | A | A | A | A |
| Plating peel test | | | | |
| Peel strength (N/cm) | 6.7 | 7.8 | 6.1 | 3.8 |
| Peel strength (N/cm) | 6.5 | 7.5 | 5.5 | 0.4 |
| after allowed to stand at | | | | |
| 150° C. for one week | | | | |

Note
*¹CP1: Copper particles 1

### INDUSTRIAL APPLICABILITY

In the conductive coating film obtained according to the present invention, a copper powder-containing coating film is formed on an insulating substrate, and the copper powder-containing coating film is subjected to a treatment with an organic acid or an organic acid salt and then to a treatment with superheated steam, so that the resulting conductive coating film is excellent in not only conductivity, but also adhesion between the conductive coating film and the insulating substrate. These conductive coating films can be used in a metal/resin laminate, a metal thin film forming material for electromagnetic shielding metal thin films, a metal wiring material, a conductive material, or the like.

1. A process for producing a conductive coating film, comprising the steps of:
applying a copper paste comprising copper particles, a binder resin and a solvent as main components onto an insulating substrate to form a coating film on the insulating substrate, and then drying the coating film to obtain a copper powder-containing coating film;
treating the copper powder-containing coating film with an organic acid or an organic acid salt; and
subjecting the thus treated copper powder-containing coating film to heat treatment with superheated steam.

2. The process for producing a conductive coating film according to claim 1, wherein the organic acid or the organic acid salt is a carboxylic acid compound, a sulfonic acid compound, a sulfuric acid compound or a metal salt, or an ammonium salt of any of these compounds.

3. A conductive coating film produced by the process according to claim 1.
